(19) United States
(12) Patent Application Publication
(10) Pub. No.: US 2017/0370403 A1
(43) Pub. Date: Dec. 28, 2017

(54) SPHERICAL SAFETY JOINT WITH MANUAL OR AUTOMATIC COUPLING AND QUICK RELEASE, WITH ADJUSTABLE FORCE

(71) Applicant: FABIO MANIERI, ROMA (IT)

(72) Inventor: FABIO MANIERI, ROMA (IT)

(21) Appl. No.: 15/543,626

(22) PCT Filed: Jan. 14, 2016
(86) PCT No.: PCT/IT2016/000007

§ 371 Date: Jul. 14, 2017

(30) Foreign Application Priority Data
Jan. 21, 2015 (IT) RM2015A000028

(51) Int. Cl. F16C 11/06

(52) U.S. Cl. CPC F16C 11/069; F16C 11/0619

(57) ABSTRACT

The subject device is an adjustable coupling and quick release safety system, both automatic and manual and is applicable at a wide range of applications. It is mainly composed of two elements called “receptacle” (1, 2, 3) and “sphere” (8). The coupling and/or the release are controlled by a spring (5) with adjustable force, the coupling and/or the release can be made for direct pressure between the two elements or manually via a lever (6). The system also allows the angular and rotational movement of the sphere (8) which may however also not to be oscillating or rotating. The current state of the technique involves articulated sphere joints with fixed coupling or with connections of different kind.

### FIELD OF THE INVENTION

This system is necessary in all those cases in which it is essential to unite the characteristics of a ball joint, a rapid connection and especially a rapid and safe disconnection. This is fundamental in all those cases of critical situations where it's necessary that two objects must quickly separate. As an example we can point to this joint for the cervical vertebrae load support systems of the helmet for helicopter pilots, aircraft, boats, cars and/or civilian or military terrestrial or amphibians like the “Balancing system for the head of a passenger of a vehicle, in particular a helicopter”, in which this coupling system is essential for easy connection and disconnection of the pilot's helmet to the system itself, for the freedom of movement given by the ball joint and in the event of an emergency exit of the pilot, for a quick and safe automatic or manual disconnection. Other fields of application, which are innumerable, can be for example in the field of general engineering, automotive, sports etc.

### THE SYSTEM IS COMPOSED BY 8 ELEMENTS

The semi fork or semi fixed receptacle, element (1), the semi fork or semi movable receptacle, element (3), the rear part of the semi fork or semi movable receptacle, element (2), the adjustable spring (5) with spring's screw (4), the lever (6), the hinge axis (7) and the spherical part (8). For a possible variant (drawings from 2/4 to 4/4) also the elements (9), (10) and (11). Parts (1,2,3,4,5,6,7) form the main assembly said “receptacle” that will be fixed in the case of vehicles inside the vehicle itself, while the spherical shank (8) will be fixed (for example, for a pilot's helmet) to the helmet itself, through suitable interface that can be fixed or trolley to allow greater freedom of movement of the head.

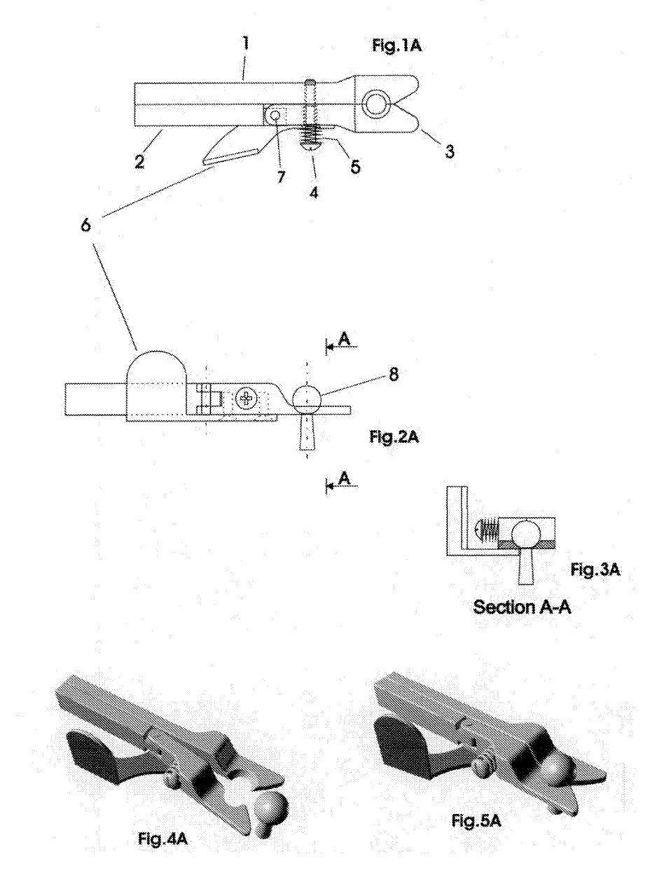

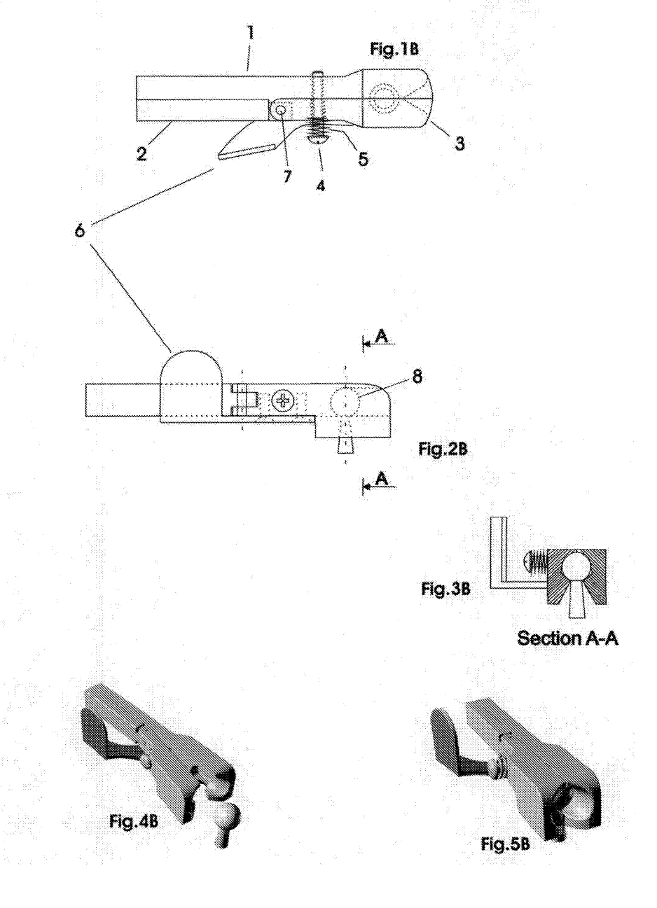

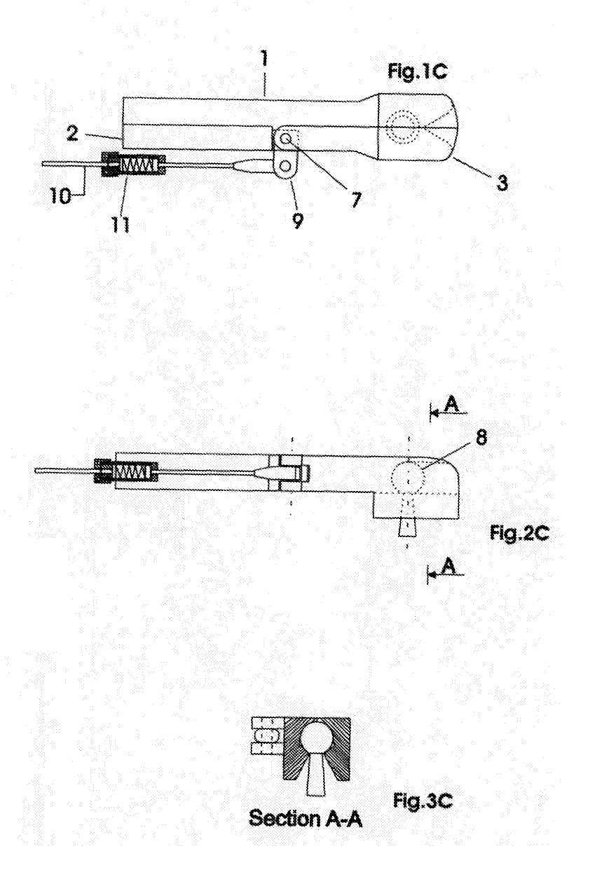

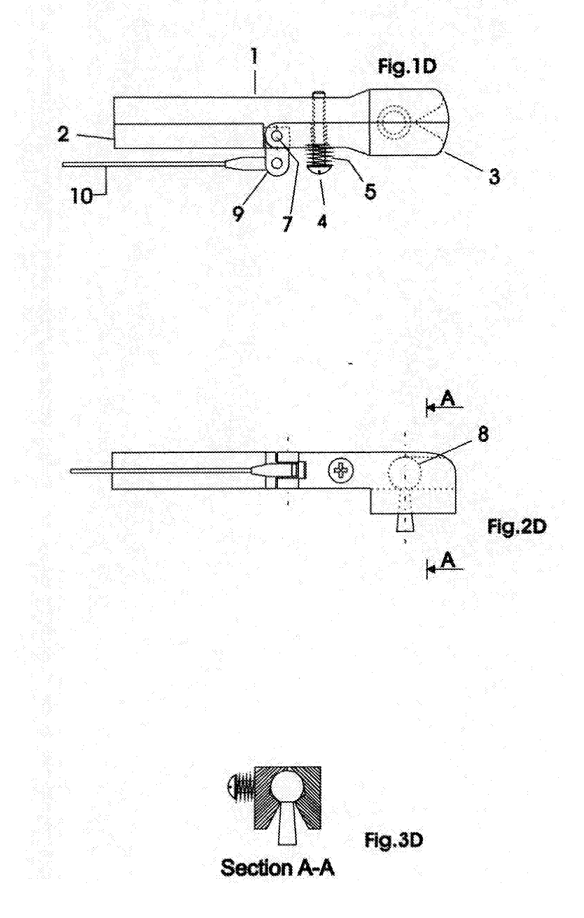

The peculiarity of the system is the ease and safety coupling and/or release with adjustable force by means of the adjusting screw of the contrast spring (4). The operation can be made both automatic or manual. The system also allows the angular and rotation movement of the sphere which may however also be non-oscillating and/or rotating. The connection and/or the release can be made by direct pressure between the two elements “receptacle” and “sphere” or manually via the lever. Since it is possible to realize the system of any size and for any application, for large systems the manual release lever, due to the high forces in play, can be replaced by a special system of amplification of the force both manual than servo assisted of any type. The working indication is represented in the FIGS. 4A-5A and 4B-5B.

### Difference Between the “A” Type and the “B” Type

The main differences are two:

1) in the manner of containment of the sphere: in the “B” type the sphere is completely included in the receptacle, while in the “A” type the sphere remains in place by means of the effect of the downward traction applied by the object's weight or by the traction force applied to it.
2) on the coupling mode: in the “B” type sphere, coupling can also be made from the bottom too and not only frontally as in the “A” type, while the release in both types can be made either downward that towards the front.
3) The possibility for the manual connection and/or release are almost identical for both types.

1. Universal joint assembly capable of joining two fixed or movable parts of any machine or mechanical structure, said joint assembly is composed of: a fixed part (1) without hinge named fixed semi receptacle, a fixed part (2) with a hinge connected to a movable part (3) with the same hinge, named movable semi receptacle, a hinge pin (7) joining the said elements (2) and (3), a spring (5) adjustable by the coaxial screw (4) capable to generate a force that contrasts the opening of the element (3) which together with the element (1) forms a receptacle for containing the sphere with shank (8), a manual release lever (6).

2. Ball joint assembly according to claim 1 characterized in that the receptacle composed of the elements (1) and (3) forms a cavity for containing the whole sphere (8).

3. Ball joint assembly according to claim 1 characterized in that the receptacle formed by the elements (1) and (3) forms a cavity for containment of the sphere so that it can have a height of containment of the sphere itself that goes from 0.1% to 100% of the diameter of the ball (8) in question.

4. Ball joint assembly according to claim 1, characterized in that the contrast spring (5) and the adjustment coaxial screw (4) are positioned instead orthogonally to the longitudinal axis of the joint, parallel with respect to it or with other variable angles between 0 and 180 degrees with respect to said axis with the possibility of transferring the spring force via angular linkage.

5. Ball joint assembly according to claim 1, having a lever (9) forming part of the semi receptacle (3) a rod (10) comprising a coaxial cylinder (11) with the contrast spring and adjustment ring acts to keep the joint closed with the desired strength in alternative to the screw (4) and the spring (5).

6. Ball joint assembly according to claim 5 having a rigid actuating rod (10).

7. Ball joint assembly according to claim 1, characterized in that the ball (8) has an internal thread in which it can insert a mechanical element with thread instead of a fixed shank.

8. Bait joint assembly according to claim 1, characterized in that the fixed back parts (1) and (2) of the joint assembly have the fixing flanges rather than the form of a straight shank.
